(19) United States
(12) Patent Application Publication
(10) Pub. No.: US 2024/0256301 A1
(43) Pub. Date: Aug. 1, 2024

(54) SYSTEMS AND METHODS FOR CONTEXT AWARE REWARD BASED GAMIFIED ENGAGEMENT

(71) Applicant: Walmart Apollo, LLC, Bentonville, AR (US)

(72) Inventors: Rahul Radhakrishnan Iyer, Sunnyvale, CA (US); Malay Kumar Patel, Fremont, CA (US); Saurabh Kumar, Fremont, CA (US); Sushant Kumar, San Jose, CA (US); Kannan Achan, Saratoga, CA (US)

(21) Appl. No.: 18/421,105

(22) Filed: Jan. 24, 2024

Related U.S. Application Data
(60) Provisional application No. 63/442,368, filed on Jan. 31, 2023.

(51) Int. Cl. G06F 9/451; G06F 40/40

(52) U.S. Cl. CPC G06F 9/451; G06F 40/40

(57) ABSTRACT

Systems and methods for context aware engagement are disclosed. A request for a user interface, including a user identifier, is received. A set of features associated with the user identifier are obtained and a user embedding is generated by applying an autoencoder to the set of features. A set of potential tasks associated with an enrollment portion of the user interface is obtained. A task embedding is generated for each task in the set of potential tasks. A user-task affinity is generated by comparing the user embedding to each task embedding. A ranked set of tasks is generated by ranking each task based on the user-task affinity. A set of interface elements related to the highest ranked tasks in the ranked set of tasks is generated. A user interface including interface elements is generated and transmitted to a device that requested the user interface.

### CROSS-REFERENCE TO RELATED APPLICATIONS

This application claims benefit to U.S. Provisional Appl. No. 63/442,368, filed 31 Jan. 2023, entitled System and Method for Context Aware Reward Based Gamified Engagement, the disclosure of which is incorporated herein by reference in its entirety.

### TECHNICAL FIELD

This application relates generally to generation of user interfaces, and more particularly, to context-aware generation of user interfaces.

### BACKGROUND

Current network interfaces allow users to interact with online systems provided by third parties, such as retailers or service providers. Provided interfaces can provide access to different benefits or interaction types for engagement with the interface. In some instances, users can access or interact with certain benefits or interactions, such as benefits provided through enrollment in loyalty or other membership programs, through a network interface. Current interfaces require users to seek out such information in specific portions of the interface.

Current interfaces provide benefit information and potential activities in predetermined portions of the interface. User's must be aware of the existence of such activities and navigate through an interface to pages associated with or including those activities. A user may not be aware of certain benefit activities or interactions that are possible or required, as a user may be newly eligible to interact with certain activities or perform certain interactions and as those interactions can be located in a previously unused portion of the interface. In some instances, a user may need to complete one or more tasks before being able to access portions of an interface or perform interactions through an interface, but may not be aware of the actions that need to be completed in order to enable the desired functionality.

### SUMMARY

In various embodiments, a system including a non-transitory memory and a processor is disclosed. The processor is communicatively coupled to the non-transitory memory and is configured to read a set of instructions to receive a request for a user interface. The request includes a user identifier. The processor is further configured to obtain a set of features from a database that are associated with the user identifier in the database and generate a user embedding by applying an autoencoder to the set of features. The processor is further configured to obtain a set of potential tasks that are associated with an enrollment portion of the user interface and generate a task embedding for each potential task in the set of potential tasks. The processor is further configured to generate a user-task affinity for each potential task by comparing the user embedding to each task embedding, generate a ranked set of tasks by ranking each potential task based on the user-task affinity, generate a set of interface elements related to a predetermined number of highest ranked tasks in the ranked set of tasks, generate the user interface including the set of interface elements, and transmit the user interface to a device that generated the request for the user interface.

In various embodiments, a computer-implemented method is disclosed. The method includes the steps of receiving a request for a user interface including a user identifier and obtaining a set of features from a database that are associated with the user identifier in the database. A user embedding is generated by applying an autoencoder to the set of features. A set of potential tasks is obtained that are associated with an enrollment portion of the user interface and a task embedding is generated for each potential task in the set of potential tasks. A user-task affinity is generated for each potential task by comparing the user embedding to each task embedding, a ranked set of tasks is generated by ranking each potential task based on the user-task affinity, and a set of interface elements related to a predetermined number of highest ranked tasks in the ranked set of tasks is generated. The user interface including the set of interface elements is generated and transmitted to a device that generated the request for the user interface.

In various embodiments, a non-transitory computer-readable storage medium storing instructions is disclosed. The instructions, when executed by a computing device, cause the computing device to perform a method including the steps of receiving a request for a user interface including a user identifier and obtaining a set of features from a database that are associated with the user identifier in the database. A user embedding is generated by applying an autoencoder to the set of features. A set of potential tasks is obtained that are associated with an enrollment portion of the user interface and a task embedding is generated for each potential task in the set of potential tasks. A user-task affinity is generated for each potential task by comparing the user embedding to each task embedding, a ranked set of tasks is generated by ranking each potential task based on the user-task affinity, and a set of interface elements related to a predetermined number of highest ranked tasks in the ranked set of tasks is generated. The user interface including the set of interface elements is generated and transmitted to a device that generated the request for the user interface.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 illustrates a computer system configured to implement one or more processes, in accordance with some embodiments;

FIG. 2 illustrates a network environment configured to generate and provide a user interface including context-aware customized interface elements, in accordance with some embodiments, in accordance with some embodiments;

FIG. 3 illustrates an artificial neural network, in accordance with some embodiments;

FIG. 4 illustrates a tree-based neural network, in accordance with some embodiments;

FIG. 5 illustrates an autoencoder network, in accordance with some embodiments;

FIG. 6 is a flowchart illustrating a method of generating an interface including a set of context-aware customized interface elements, in accordance with some embodiments;

FIG. 7 is a process flow illustrating various steps of the method of generating an interface including a set of context-aware customized interface elements, in accordance with some embodiments;

FIG. 8 illustrates a trained word2vec encoding network, in accordance with some embodiments;

FIG. 9 illustrates a task tracking engine including a task tracking state machine, in accordance with some embodiments;

FIG. 10 is a flowchart illustrating a method of generating a trained encoding model, in accordance with some embodiments;

FIG. 11 is a process flow illustrating various steps of the generating a trained encoding model, in accordance with some embodiments;

FIG. 12 is a flowchart illustrating a method of training an autoencoder, in accordance with some embodiments; and

FIG. 13 is a process flow illustrating various steps of the method of training an autoencoder network, in accordance with some embodiments.

### DETAILED DESCRIPTION

This description of the exemplary embodiments is intended to be read in connection with the accompanying drawings, which are to be considered part of the entire written description. The drawing figures are not necessarily to scale and certain features of the invention may be shown exaggerated in scale or in somewhat schematic form in the interest of clarity and conciseness. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein can be assigned to the other claimed objects and vice versa. In other words, claims for the systems can be improved with features described or claimed in the context of the methods. In this case, the functional features of the method are embodied by objective units of the systems.

Furthermore, in the following, various embodiments are described with respect to methods and systems for generating a user interface including context-aware customized interface elements. In various embodiments an interface generation engine is configured to generate an interface, such as a network or mobile device interface, that identifies (e.g., provides links to, pop-ups regarding, etc.) context-specific actions or activities that can be performed by a user. The generated interface includes one or more context-aware customized interface elements configured to encourage and simplify interaction with interface elements related to the completion of tasks. The customized interface elements can be configured to identify benefit-based activities that are likely to be utilized by a user for a given context.

In some embodiments, systems and methods for generating a user interface that includes context-aware, customized interface elements includes one or more trained affinity models configured to determine a user affinity for context-available tasks. The trained affinity models can include embedding layers configured to generate embeddings, such as task or user embeddings, comparison layers for identifying affinities between a user and a task based on the generated embeddings, and/or ranking layers ranking the user-task affinities. In some embodiments, the systems and methods for generating a user interface that includes context-aware, customized interface elements are configured to provide context-aware task tracking for identification of context-specific tasks.

In general, a trained function mimics cognitive functions that humans associate with other human minds. In particular, by training based on training data the trained function is able to adapt to new circumstances and to detect and extrapolate patterns.

In general, parameters of a trained function can be adapted by means of training. In particular, a combination of supervised training, semi-supervised training, unsupervised training, reinforcement learning and/or active learning can be used. Furthermore, representation learning (an alternative term is “feature learning”) can be used. In particular, the parameters of the trained functions can be adapted iteratively by several steps of training.

In particular, a trained function can comprise a neural network, a support vector machine, a decision tree and/or a Bayesian network, and/or the trained function can be based on k-means clustering, Qlearning, genetic algorithms and/or association rules. In particular, a neural network can be a deep neural network, a convolutional neural network, or a convolutional deep neural network. Furthermore, a neural network can be an adversarial network, a deep adversarial network and/or a generative adversarial network.

In various embodiments, a neural network which is trained (e.g., configured or adapted) to generate task and/or user embeddings and determine an affinity between the generated embeddings, is disclosed. A neural network trained to generate task and/or user embeddings and determine an affinity between the generated embeddings may be referred to as a trained affinity network and/or a trained affinity model. A trained affinity network can be configured to generate embeddings using any suitable process. For example, in various embodiments, a trained affinity network can include a word2vec embedding generation process to generate embedding vectors representative of one or more tasks, a trained autoencoding process to generate embedding vectors representative of a user, and/or any other suitable embedding encoding process.

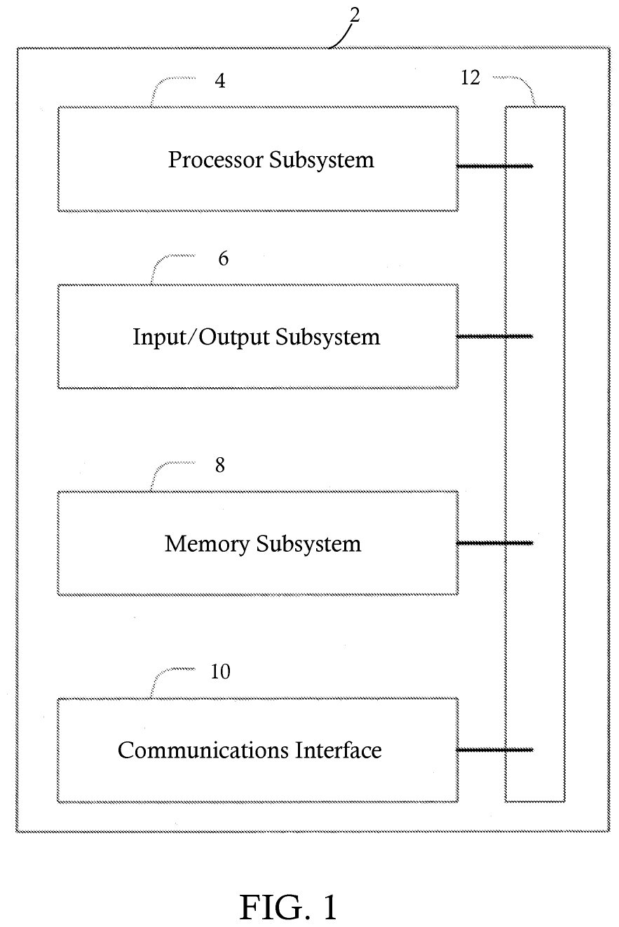

FIG. 1 illustrates a computer system configured to implement one or more processes, in accordance with some embodiments. The system 2 is a representative device and can include a processor subsystem 4, an input/output subsystem 6, a memory subsystem 8, a communications interface 10, and a system bus 12. In some embodiments, one or more than one of the system 2 components can be combined or omitted such as, for example, not including an input/output subsystem 6. In some embodiments, the system 2 can include other components not combined or comprised in those shown in FIG. 1. For example, the system 2 can also include, for example, a power subsystem. In other embodiments, the system 2 can include several instances of the components shown in FIG. 1. For example, the system 2 can include multiple memory subsystems 8. For the sake of conciseness and clarity, and not limitation, one of each of the components is shown in FIG. 1.

The processor subsystem 4 can include any processing circuitry operative to control the operations and performance of the system 2. In various aspects, the processor subsystem 4 can be implemented as a general purpose processor, a chip multiprocessor (CMP), a dedicated processor, an embedded processor, a digital signal processor (DSP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The processor subsystem 4 also can be implemented by a controller, a microcontroller, an application specific integrated circuit (ASIC), a field programmable gate array (FPGA), a programmable logic device (PLD), and so forth.

In various aspects, the processor subsystem 4 can be arranged to run an operating system (OS) and various applications. Examples of an OS comprise, for example, operating systems generally known under the trade name of Apple OS, Microsoft Windows OS, Android OS, Linux OS, and any other proprietary or open-source OS. Examples of applications comprise, for example, network applications, local applications, data input/output applications, user interaction applications, etc.

In some embodiments, the system 2 can include a system bus 12 that couples various system components including the processor subsystem 4, the input/output subsystem 6, and the memory subsystem 8. The system bus 12 can be any of several types of bus structure(s) including a memory bus or memory controller, a peripheral bus or external bus, and/or a local bus using any variety of available bus architectures including, but not limited to, 9-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect Card International Association Bus (PCMCIA), Small Computers Interface (SCSI) or other proprietary bus, or any custom bus suitable for computing device applications.

In some embodiments, the input/output subsystem 6 can include any suitable mechanism or component to enable a user to provide input to system 2 and the system 2 to provide output to the user. For example, the input/output subsystem 6 can include any suitable input mechanism, including but not limited to, a button, keypad, keyboard, click wheel, touch screen, motion sensor, microphone, camera, etc.

In some embodiments, the input/output subsystem 6 can include a visual peripheral output device for providing a display visible to the user. For example, the visual peripheral output device can include a screen such as, for example, a Liquid Crystal Display (LCD) screen. As another example, the visual peripheral output device can include a movable display or projecting system for providing a display of content on a surface remote from the system 2. In some embodiments, the visual peripheral output device can include a coder/decoder, also known as Codecs, to convert digital media data into analog signals. For example, the visual peripheral output device can include video Codecs, audio Codecs, or any other suitable type of Codec.

The visual peripheral output device can include display drivers, circuitry for driving display drivers, or both. The visual peripheral output device can be operative to display content under the direction of the processor subsystem 4. For example, the visual peripheral output device may be able to play media playback information, application screens for application implemented on the system 2, information regarding ongoing communications operations, information regarding incoming communications requests, or device operation screens, to name only a few.

In some embodiments, the communications interface 10 can include any suitable hardware, software, or combination of hardware and software that is capable of coupling the system 2 to one or more networks and/or additional devices. The communications interface 10 can be arranged to operate with any suitable technique for controlling information signals using a desired set of communications protocols, services, or operating procedures. The communications interface 10 can include the appropriate physical connectors to connect with a corresponding communications medium, whether wired or wireless.

Vehicles of communication comprise a network. In various aspects, the network can include local area networks (LAN) as well as wide area networks (WAN) including without limitation Internet, wired channels, wireless channels, communication devices including telephones, computers, wire, radio, optical or other electromagnetic channels, and combinations thereof, including other devices and/or components capable of/associated with communicating data. For example, the communication environments comprise in-body communications, various devices, and various modes of communications such as wireless communications, wired communications, and combinations of the same.

Wireless communication modes comprise any mode of communication between points (e.g., nodes) that utilize, at least in part, wireless technology including various protocols and combinations of protocols associated with wireless transmission, data, and devices. The points comprise, for example, wireless devices such as wireless headsets, audio and multimedia devices and equipment, such as audio players and multimedia players, telephones, including mobile telephones and cordless telephones, and computers and computer-related devices and components, such as printers, network-connected machinery, and/or any other suitable device or third-party device.

Wired communication modes comprise any mode of communication between points that utilize wired technology including various protocols and combinations of protocols associated with wired transmission, data, and devices. The points comprise, for example, devices such as audio and multimedia devices and equipment, such as audio players and multimedia players, telephones, including mobile telephones and cordless telephones, and computers and computer-related devices and components, such as printers, network-connected machinery, and/or any other suitable device or third-party device. In various implementations, the wired communication modules can communicate in accordance with a number of wired protocols. Examples of wired protocols can include Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, to name only a few examples.

Accordingly, in various aspects, the communications interface 10 can include one or more interfaces such as, for example, a wireless communications interface, a wired communications interface, a network interface, a transmit interface, a receive interface, a media interface, a system interface, a component interface, a switching interface, a chip interface, a controller, and so forth. When implemented by a wireless device or within wireless system, for example, the communications interface 10 can include a wireless interface comprising one or more antennas, transmitters, receivers, transceivers, amplifiers, filters, control logic, and so forth.

In various aspects, the communications interface 10 can provide data communications functionality in accordance with a number of protocols. Examples of protocols can include various wireless local area network (WLAN) protocols, including the Institute of Electrical and Electronics Engineers (IEEE) 802.xx series of protocols, such as IEEE 802.11a/b/g/n/ac/ax/be, IEEE 802.16, IEEE 802.20, and so forth. Other examples of wireless protocols can include various wireless wide area network (WWAN) protocols, such as GSM cellular radiotelephone system protocols with GPRS, CDMA cellular radiotelephone communication systems with 1×RTT, EDGE systems, EV-DO systems, EV-DV systems, HSDPA systems, the Wi-Fi series of protocols including Wi-Fi Legacy, Wi-Fi 1/2/3/4/5/6/6E, and so forth. Further examples of wireless protocols can include wireless personal area network (PAN) protocols, such as an Infrared protocol, a protocol from the Bluetooth Special Interest Group (SIG) series of protocols (e.g., Bluetooth Specification versions 5.0, 6, 7, legacy Bluetooth protocols, etc.) as well as one or more Bluetooth Profiles, and so forth. Yet another example of wireless protocols can include near-field communication techniques and protocols, such as electromagnetic induction (EMI) techniques. An example of EMI techniques can include passive or active radio-frequency identification (RFID) protocols and devices. Other suitable protocols can include Ultra-Wide Band (UWB), Digital Office (DO), Digital Home, Trusted Platform Module (TPM), ZigBee, and so forth.

In some embodiments, at least one non-transitory computer-readable storage medium is provided having computer-executable instructions embodied thereon, wherein, when executed by at least one processor, the computer-executable instructions cause the at least one processor to perform embodiments of the methods described herein. This computer-readable storage medium can be embodied in memory subsystem 8.

In some embodiments, the memory subsystem 8 can include any machine-readable or computer-readable media capable of storing data, including both volatile/non-volatile memory and removable/non-removable memory. The memory subsystem 8 can include at least one non-volatile memory unit. The non-volatile memory unit is capable of storing one or more software programs. The software programs can contain, for example, applications, user data, device data, and/or configuration data, or combinations therefore, to name only a few. The software programs can contain instructions executable by the various components of the system 2.

In various aspects, the memory subsystem 8 can include any machine-readable or computer-readable media capable of storing data, including both volatile/non-volatile memory and removable/non-removable memory. For example, memory can include read-only memory (ROM), random-access memory (RAM), dynamic RAM (DRAM), Double-Data-Rate DRAM (DDR-RAM), synchronous DRAM (SDRAM), static RAM (SRAM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, disk memory (e.g., floppy disk, hard drive, optical disk, magnetic disk), or card (e.g., magnetic card, optical card), or any other type of media suitable for storing information.

In one embodiment, the memory subsystem 8 can contain an instruction set, in the form of a file for executing various methods, such as methods for generating a user interface including context-aware, customized interface elements, includes one or more trained affinity models configured to determine a user affinity for context-available tasks, as described herein. The instruction set can be stored in any acceptable form of machine-readable instructions, including source code or various appropriate programming languages. Some examples of programming languages that can be used to store the instruction set comprise, but are not limited to: Java, C, C++, C#, Python, Objective-C, Visual Basic, or .NET programming. In some embodiments a compiler or interpreter is comprised to convert the instruction set into machine executable code for execution by the processor subsystem 4.

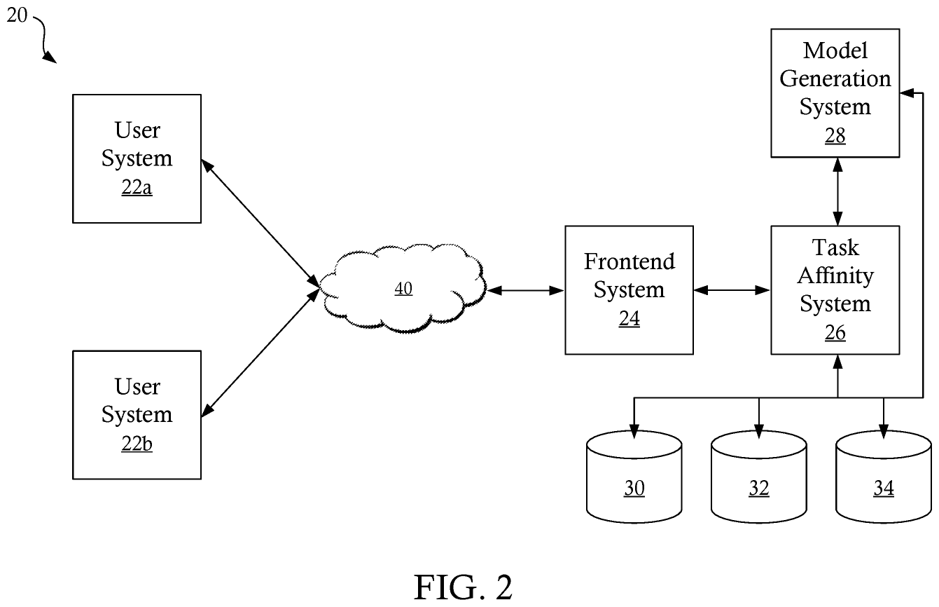

FIG. 2 illustrates a network environment 20 configured to generate and provide a user interface including context-aware, customized interface elements, in accordance with some embodiments. The network environment 20 includes a plurality of systems configured to communicate over one or more network channels, illustrated as network cloud 40. For example, in various embodiments, the network environment 20 can include, but is not limited to, one or more user systems 22a, 22b, a frontend system 24, a task affinity system 26, a model generation system 28, a task database 30, a user information database 32, a model store database 34, and/or any other suitable systems or elements. Although embodiments are discussed herein including the illustrated network environment 20, it will be appreciated that the network environment 20 can include additional systems not illustrated, for example, additional instances of illustrated systems and/or additional networked systems. In addition, it will be appreciated that two or more the illustrated systems can be combined into a single system.

In some embodiments, the user systems 22a, 22b are configured to provide a user interface to allow a user to interact with services and/or resources provided by a network system, such as frontend system 24. The user interface can include any suitable interface, such as, for example, a mobile device application interface, a network interface, and/or any other suitable interface. For example, in some embodiments, the frontend system 24 includes an interface generation engine configured to generate a customized network interface and provide the customized network interface, and/or instructions for generating the customized network interface, to a user system 22a, 22b, which displays the user interface via one or more display elements. The customized network interface can include any suitable network interface, such as, for example, an e-commerce interface, a service interface, an intranet interface, and/or any other suitable user interface. In some embodiments, the customized interface includes a webpage, web portal, intranet page, application page, and/or other interactive interface. The customized network interface includes at least one customized interface element configured to identify a context-appropriate task. The context-appropriate task can be selected by a trained affinity model. In some embodiments, the context-appropriate task is embodied in an interface element related to an enrollment program including current or future tasks for completion in relation to the enrollment program.

In some embodiments, the frontend system 24 is in data communication with a task affinity system 26 configured to identify current and/or future tasks for inclusion in a customized user interface and/or configured to track task engagement and completion in response to presented interface elements in the generated interface. For example, in some embodiments, an affinity engine is configured to implement one or more trained affinity models configured to receive a user identifier and select a set of customized, context-appropriate tasks or activities for presentation to a user through the user interface. In some embodiments, the task affinity system 26 is configured to receive feedback regarding completion of tasks and generate additional sets of customized tasks based on the received feedback data.

In some embodiments, the affinity engine can implement any suitable trained machine learning model(s) configured to receive user features and one or more tasks and generate a set of customized user tasks based on an affinity between the user features and the one or more tasks. In some embodiments, the affinity engine implements one or more embedding generation layers/models, an affinity layer/model, and a ranking layer/model. As discussed in greater detail below, the embedding generation layers/models are configured to generate embeddings for a received user identifier (based on user features associated with the user identifier) and/or the one or more tasks, the affinity layer/model is configured to predict an affinity between a user and a task based on the generated embeddings, and the ranking layer/model is configured to rank each of the tasks based on the affinity between the user and the task.

In some embodiments, the affinity engine is configured to obtain one or more trained models from a model store database 34. The trained models, such as one or more trained embedding encoding models, include various parameters and/or layers configured to receive one or more user feature inputs or task inputs and generate vector embeddings representative of the received features and/or task. For example, in various embodiments, autoencoding networks, such as a word2vec or other autoencoding network, can be configured to generate a vector embedding representative of an input. In some embodiments, a trained affinity model is configured to receive vector embeddings representative of a user and a plurality of tasks and generate an affinity (e.g., a probability of interaction) between the user and each of the tasks. In some embodiments, a trained ranking model is configured to rank the affinity of each task with respect to the user.

In some embodiments, the trained models can be generated by a model generation system 28. The model generation system 28 is configured to generate one or more trained models using, for example, iterative training processes. For example, in some embodiments, a model training engine is configured to receive historical data and utilize the historical data to generate one or more trained encoding models, a trained affinity model, and/or a trained ranking model. The historical data can be stored, for example, in a task database 30, a user information database 32, and/or any other suitable database. In some embodiments, the training process utilizes labeled data such as training data including user profiles and/or features associated with user profiles associated with particular tasks.

In various embodiments, the system or components thereof can comprise or include various modules or engines, each of which is constructed, programmed, configured, or otherwise adapted, to autonomously carry out a function or set of functions. A module/engine can include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine can also be implemented as a combination of the two, with certain functions facilitated by hardware alone, and other functions facilitated by a combination of hardware and software. In certain implementations, at least a portion, and in some cases, all, of a module/engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine can be realized in a variety of physically realizable configurations, and should generally not be limited to any particular implementation exemplified herein, unless such limitations are expressly called out. In addition, a module/engine can itself be composed of more than one sub-modules or sub-engines, each of which can be regarded as a module/engine in its own right. Moreover, in the embodiments described herein, each of the various modules/engines corresponds to a defined autonomous functionality; however, it should be understood that in other contemplated embodiments, each functionality can be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the examples herein.

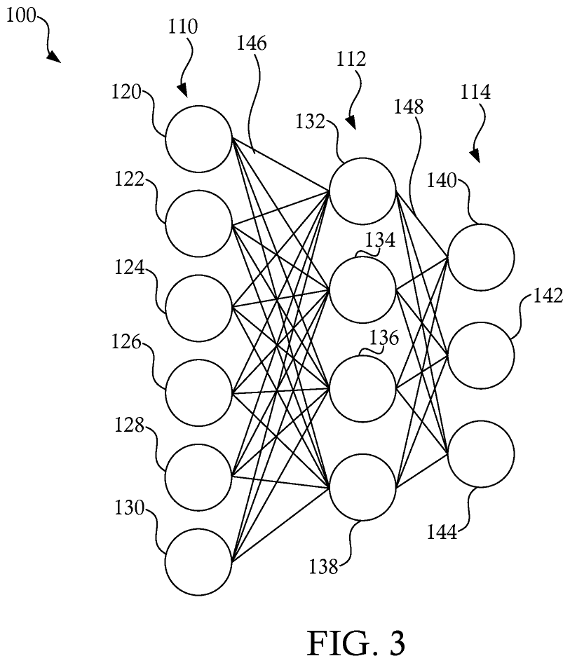

FIG. 3 illustrates an artificial neural network 100, in accordance with some embodiments. Alternative terms for “artificial neural network” are “neural network,” “artificial neural net,” “neural net,” or “trained function.” The neural network 100 comprises nodes 120-144 and edges 146-148, wherein each edge 146-148 is a directed connection from a first node 120-138 to a second node 132-144. In general, the first node 120-138 and the second node 132-144 are different nodes, although it is also possible that the first node 120-138 and the second node 132-144 are identical. For example, in FIG. 3 the edge 146 is a directed connection from the node 120 to the node 132, and the edge 148 is a directed connection from the node 132 to the node 140. An edge 146-148 from a first node 120-138 to a second node 132-144 is also denoted as “ingoing edge” for the second node 132-144 and as “outgoing edge” for the first node 120-138.

The nodes 120-144 of the neural network 100 can be arranged in layers 110-114, wherein the layers can comprise an intrinsic order introduced by the edges 146-148 between the nodes 120-144. In particular, edges 146-148 can exist only between neighboring layers of nodes. In the illustrated embodiment, there is an input layer 110 comprising only nodes 120-130 without an incoming edge, an output layer 114 comprising only nodes 140-144 without outgoing edges, and a hidden layer 112 in-between the input layer 110 and the output layer 114. In general, the number of hidden layer 112 can be chosen arbitrarily and/or through training. The number of nodes 120-130 within the input layer 110 usually relates to the number of input values of the neural network, and the number of nodes 140-144 within the output layer 114 usually relates to the number of output values of the neural network.

In particular, a (real) number can be assigned as a value to every node 120-144 of the neural network 100. Here, xᵢ⁽ⁿ⁾ denotes the value of the i-th node 120-144 of the n-th layer 110-114. The values of the nodes 120-130 of the input layer 110 are equivalent to the input values of the neural network 100, the values of the nodes 140-144 of the output layer 114 are equivalent to the output value of the neural network 100. Furthermore, each edge 146-148 can comprise a weight being a real number, in particular, the weight is a real number within the interval [−1, 1] or within the interval [0, 1]. Here, w_{i,j}^{(m,n)} denotes the weight of the edge between the i-th node 120-138 of the m-th layer 110, 112 and the j-th node 132-144 of the n-th layer 112, 114. Furthermore, the abbreviation w_{i,j}⁽ⁿ⁾ is defined for the weight w_{i,j}^{(n,n+1)}.

In particular, to calculate the output values of the neural network 100, the input values are propagated through the neural network. In particular, the values of the nodes 132-144 of the (n+1)-th layer 112, 114 can be calculated based on the values of the nodes 120-138 of the n-th layer 110, 112 by

$${x}_{j}^{( n + 1 )} = f ( {\sum }_{i} {x}_{i}^{( n )} \cdot {w}_{i , j}^{( n )} )$$

Herein, the function f is a transfer function (another term is “activation function”). Known transfer functions are step functions, sigmoid function (e.g., the logistic function, the generalized logistic function, the hyperbolic tangent, the Arctangent function, the error function, the smooth step function) or rectifier functions. The transfer function is mainly used for normalization purposes.

In particular, the values are propagated layer-wise through the neural network, wherein values of the input layer 110 are given by the input of the neural network 100, wherein values of the hidden layer(s) 112 can be calculated based on the values of the input layer 110 of the neural network and/or based on the values of a prior hidden layer, etc.

In order to set the values w_{i,j}^{(m,n)} for the edges, the neural network 100 has to be trained using training data. In particular, training data comprises training input data and training output data. For a training step, the neural network 100 is applied to the training input data to generate calculated output data. In particular, the training data and the calculated output data comprise a number of values, said number being equal with the number of nodes of the output layer.

In particular, a comparison between the calculated output data and the training data is used to recursively adapt the weights within the neural network 100 (backpropagation algorithm). In particular, the weights are changed according to

$${w}_{i , j}^{′ ( n )} = {w}_{i , j}^{( n )} - γ \cdot {δ}_{j}^{( n )} \cdot {x}_{i}^{( n )}$$

wherein γ is a learning rate, and the numbers δⱼ⁽ⁿ⁾ can be recursively calculated as

$${δ}_{j}^{( n )} = ( {\sum }_{k} {δ}_{k}^{( n + 1 )} \cdot {w}_{j , k}^{( n + 1 )} ) \cdot {f}^{′} ( {\sum }_{i} {x}_{i}^{( n )} \cdot {w}_{i , j}^{( n )} )$$

based on δⱼ⁽ⁿ⁺¹⁾, if the (n+1)-th layer is not the output layer, and

$${δ}_{j}^{( n )} = ( {x}_{k}^{( n + 1 )} - {t}_{j}^{( n + 1 )} ) \cdot {f}^{′} ( {\sum }_{i} {x}_{i}^{( n )} \cdot {w}_{i , j}^{( n )} )$$

if the (n+1)-th layer is the output layer 114, wherein f′ is the first derivative of the activation function, and yⱼ⁽ⁿ⁺¹⁾ is the comparison training value for the j-th node of the output layer 114.

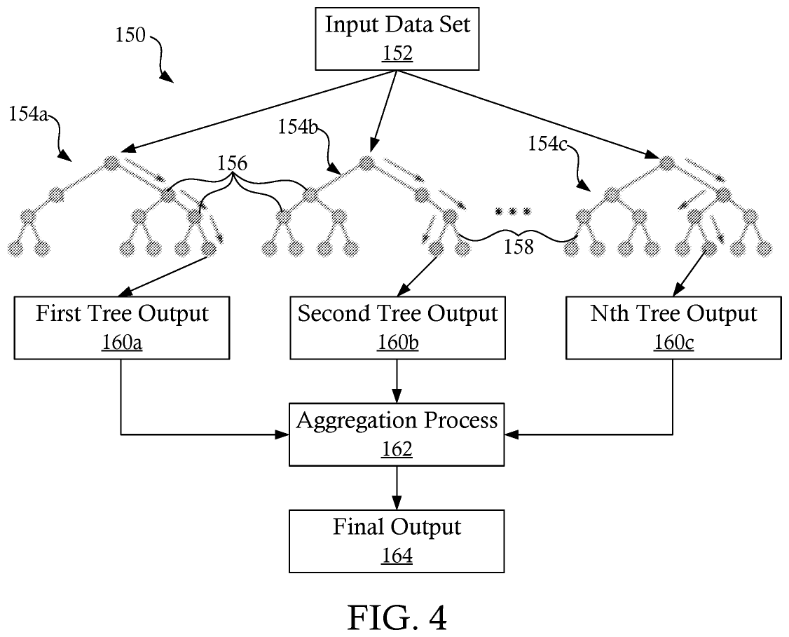

FIG. 4 illustrates a tree-based neural network 150, in accordance with some embodiments. In particular, the tree-based neural network 150 is a random forest neural network, though it will be appreciated that the discussion herein is applicable to other decision tree neural networks. The tree-based neural network 150 includes a plurality of trained decision trees 154a-154c each including a set of nodes 156 (also referred to as “leaves”) and a set of edges 158 (also referred to as “branches”).

Each of the trained decision trees 154a-154c can include a classification and/or a regression tree (CART). Classification trees include a tree model in which a target variable can take a discrete set of values, e.g., can be classified as one of a set of values. In classification trees, each leaf 156 represents class labels and each of the branches 158 represents conjunctions of features that connect the class labels. Regression trees include a tree model in which the target variable can take continuous values (e.g., a real number value).

In operation, an input data set 152 including one or more features or attributes is received. A subset of the input data set 152 is provided to each of the trained decision trees 154a-154c. The subset can include a portion of and/or all of the features or attributes included in the input data set 152. Each of the trained decision trees 154a-154c is trained to receive the subset of the input data set 152 and generate a tree output value 160a-160c, such as a classification or regression output. The individual tree output value 160a-160c is determined by traversing the trained decision trees 154a-154c to arrive at a final leaf (or node) 156.

In some embodiments, the tree-based neural network 150 applies an aggregation process 162 to combine the output of each of the trained decision trees 154a-154c into a final output 164. For example, in embodiments including classification trees, the tree-based neural network 150 can apply a majority-voting process to identify a classification selected by the majority of the trained decision trees 154a-154c. As another example, in embodiments including regression trees, the tree-based neural network 150 can apply an average, mean, and/or other mathematical process to generate a composite output of the trained decision trees. The final output 164 is provided as an output of the tree-based neural network 150.

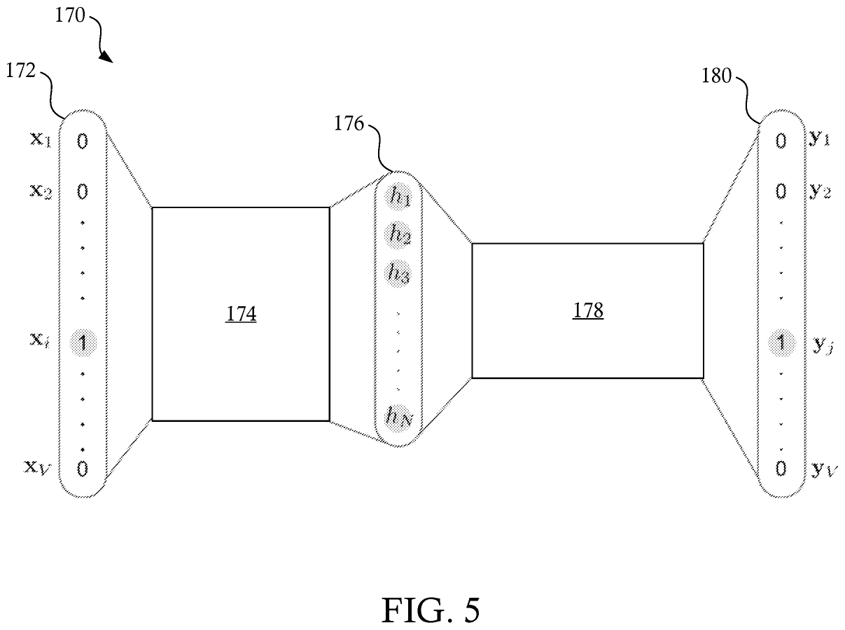

FIG. 5 illustrates an encoder-decoder network 170, in accordance with some embodiments. The encoder-decoder network 170 includes an input layer 172 configured to receive an input, e.g., a task word or phrase, a set of features, etc. An embedding matrix 174 (also referred to as an encoding layer) is configured to convert the input from the input layer 172 into an N-dimensional vector representation 176. The N-dimensional vector representation 176 is referred to as an embedding representation of the input. The embedding matrix 174 includes a plurality of hidden layers and associated weights configured to convert the input to the N-dimensional vector representation 176. A context matrix 178 (also referred to as a decoding layer) is configured to convert the N-dimensional vector representation 176 to an output at the output layer 180.

The encoder-decoder network 170 can be truncated to generate an autoencoder and/or auto-decoder network. For example, in some embodiments, the encoding-decoding network 170 can be truncated to remove the context matrix 178 and the output layer 180. The remaining layers, e.g., the input layer 172, the embedding matrix 174, and the N-dimensional vector representation 176 layer are referred to as an autoencoder. Autoencoders are configured to receive an input and generate an embedding, e.g., the N-dimensional vector representation 176, as an output. The generated embeddings can be used for subsequent machine learning processes, as discussed in greater detail herein.

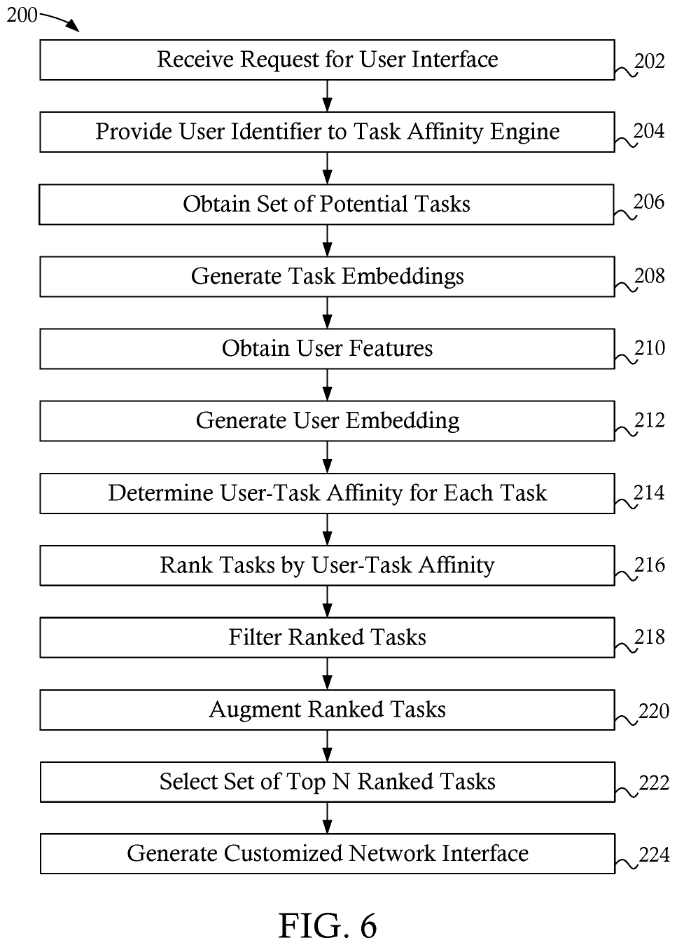

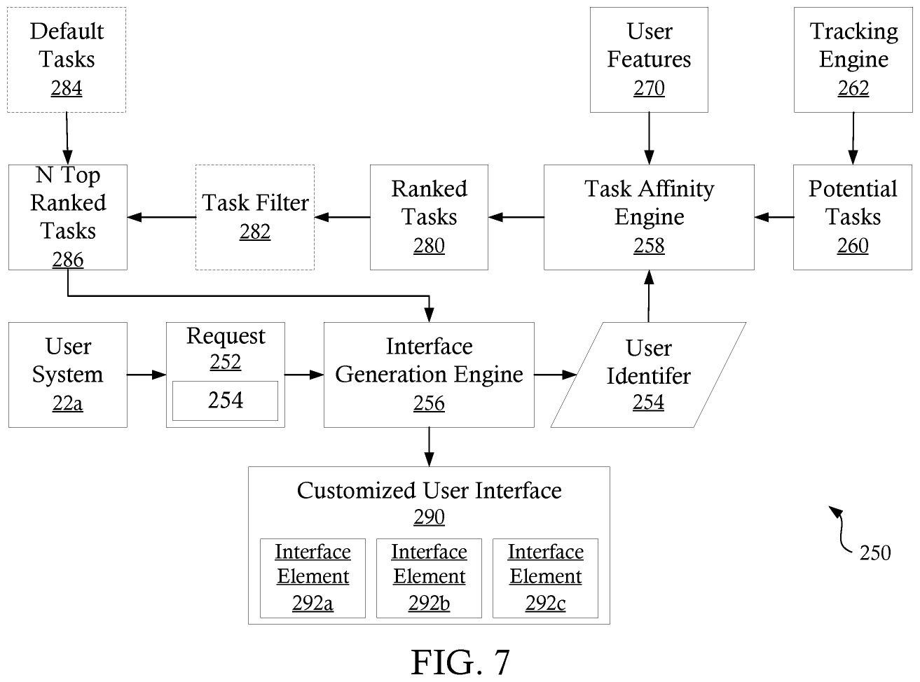

FIG. 6 is a flowchart illustrating a method 200 of generating an interface including a set of context-aware customized interface elements, in accordance with some embodiments. FIG. 7 is a process flow 250 illustrating various steps of the method of generating an interface including a set of context-aware customized interface elements, in accordance with some embodiments. At step 202, a request 252 for a user interface is received by an interface generation engine 256. The request 252 can be received from a user system 22a, 22b configured to provide a user interface to a user. In some embodiments, the request 252 includes a user identifier 254 associated with a user and/or the user system 22a, 22b. The user identifier can be generated by any suitable mechanism, such as, for example, a cookie, beacon, and/or other identifier stored on and/or provided to a user system 22a, 22b.

At step 204, the user identifier 254 is provided to a task affinity engine 258 and, at step 206, a set of potential tasks 260 is obtained for the user identifier 254, for example, by the task affinity engine 258. The set of potential tasks 260 can be obtained from any suitable engine and/or storage mechanism, such as, for example, a task database 30. In some embodiments, a task tracking engine 262 can be configured to track task completion associated with user identifiers and provide a set of context-relevant available tasks for a particular user. For example, and as discussed in greater detail below, in some embodiments the task tracking engine 262 can include a task tracking state machine configured to monitor task availability and/or completion of various tasks for a user. Available tasks can include, but are not limited to, tasks that have not yet been completed by a user, tasks that can be repeated by a user, tasks that were incorrectly completed by a user, new tasks added to the system, and/or any other suitable tasks.

In some embodiments, the set of potential tasks 260 is extracted from a raw transactional data stream. For example, stream data can be viewed and/or formatted as a document, with individual transactions each including benefits available through an enrollment program. The benefits can be encoded as individual words within the document, e.g., within the document representative of a transaction. As discussed in greater detail below, an encoding model, such as a word2vec model, can be applied to the document representation of the stream data to extract embeddings for various tasks based on identified benefits therein. In addition, by treating the transactional data stream as a document, an encoding model, such as word2vec, is able to utilize context around the transactions, e.g., additional words in the document, other transactions, etc., to extract representations of the individual words, e.g., the individual tasks available for a user.

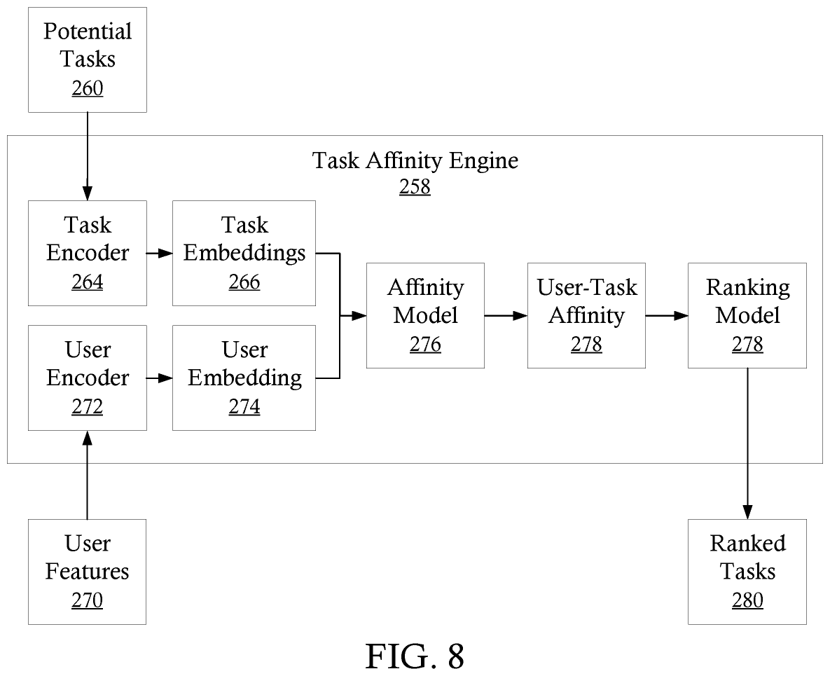

As further illustrated in FIG. 8, at step 208, a set of task embeddings 266 including an embedding for each task in the set of potential tasks 260 is generated. The task embeddings 266 can be generated by one or more task encoding models 264. The task encoding models 264 can include trained machine learning models configured to receive a task from the set of potential tasks 260 and generate a vector embedding representation of the task, such as, for example, one or more autoencoding models. Although embodiments are illustrated with a separate task encoding model 264, it will be appreciated that the task encoding model 264 can be integrated into a trained model configured to perform additional operations, such as, for example, generate a user embedding and/or determine a user-task affinity, as discussed in greater detail below.

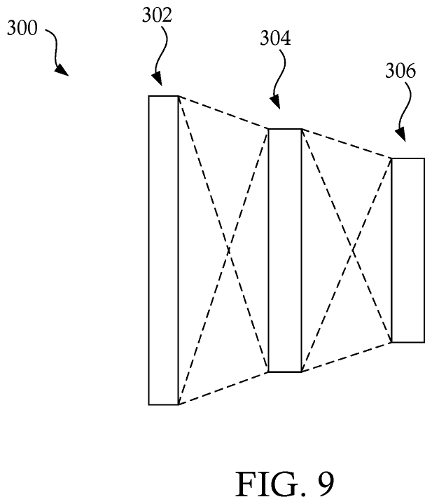

In some embodiments, the task encoding model 264 includes a trained word2vec encoding model. As shown in FIG. 9, a trained word2vec encoding model 300 includes an autoencoding model configured to receive an input, e.g., a task word or phrase, and generate a vector representation of the given input. In some embodiments, a word2vec encoding model 300 includes a task input layer 302, an embedding matrix 304 and an N-dimensional vector 306. The context matrix and task output layer, which are used during training of the word2vec encoding model 300, have been truncated. The task input layer 302 receives a task input, such as a textual task label or title. As shown in FIG. 8, each task represents a unique task label or title and thus can be represented as a unique position within a V-dimensional vector, where V is the total number of tasks that can be encoded by the word2vec encoding model 300. In some embodiments, the task input layer 302 includes a first encoding, such as a one-hot encoding, of a benefit and/or task extracted from the transactional data stream.

An embedding is generated for the received input, e.g., for the first encoding at the task input layer 302 of the textual task label or title, by an embedding matrix 304 that includes a plurality of hidden layers configured to convert the textual task label or title into an N-dimensional vector 306. Each task label or title is encoded in a unique N-dimensional vector 306 by the hidden layers of the embedding matrix 304. As discussed in greater detail below, the N-dimensional vector 306, e.g., the embedding of the task, is provided to a trained affinity model for comparison to a user embedding. The embedding matrix 304 includes a plurality of weights at one or more layers determined by an iterative training process, as discussed in greater detail below.

At step 210, a set of user features 270 associated with the user identifier 254 is received and/or obtained, for example, by the task affinity engine 258. The user features 270 can be received from any suitable system or storage mechanism. For example, in some embodiments, user features 270 can be retrieved from a database, such as user information database 32. The user features 270 can include any suitable features associated with a user and/or a user system 22a, 22b, such as, for example, transactional features, demographic features, enrollment program features, intent features, engagement features, recency, frequency, monetary value (RFM) features, and/or additional features.

In some embodiments, a set of transactional features can include, but is not limited to, transaction sources (e.g., web orders, in-store orders, etc.), look-back periods (e.g., 30 days, 60 days, 90 days), transactions associated with a predetermined period (such as a trial period for an enrollment program), transactions including predetermined items and/or predetermined categories, total expenses associated with a transaction, average expenses for all transactions, a transaction interval, a transaction regularity, and/or any other transactional features. Transactional data can include both historical data, e.g., data representative of prior transactional interactions with one or more systems associated with, for example, a particular retailer or service provider, and real-time data, e.g., data representative of a current interaction with one or more systems associated with, for example, the particular retailer or service provider.

In some embodiments, a set of demographic features can include, but is not limited to, age, gender, occupation, income, vehicle ownership, education level, and/or other information related to an individual associated with the user identifier. Demographic features can be obtained from the user, for example during interactions with a user interface, and/or can be obtained from a third party data provider. In some embodiments, demographic information is partially anonymized prior to being associated with a user profile. For example, in some embodiments, demographic features can be converted into bands or buckets that associate a user identifier with a particular segment of a population, e.g., individuals 18-35, individuals within a particular zip code, without providing exact identifying information for a particular user (e.g., without providing an exact age).

In some embodiments, a set of enrollment program features can include, but is not limited to, historical interaction data associated with one or more benefits of an enrollment program. For example, a set of enrollment program features can include data associated with historical transaction fulfillment, indicating a number of transactions that were completed via pickup, local delivery, and/or carrier shipping. Similarly, a set of communication features can include data associated with a value, such as a monetary and/or time value, associated with historical transaction fulfillment, indicating a total value amount (e.g., a total monetary value, a total time value) associated with particular fulfillment methods.

In some embodiments, a set of intent features can include, but is not limited to, fulfillment intent type (e.g., items for pickup, local delivery, shipping, etc.), a consideration intent type (e.g., intents related to categories of items such as grocery, general merchandise, etc.), interaction intents (e.g., historical data associated with interaction behaviors), a fulfillment cancellation ratio (e.g., ratio of placed to cancelled orders for a given fulfillment method), and/or any other suitable intent features. Intent features can be generated by one or more intent modules configured to infer and/or generate intent types based on historical and/or real-time interaction data associated with a user identifier.

In some embodiments, a set of engagement features include features representative of a current and/or historical engagement level of a user with respect to the network interface and/or portions of the network interface associated with one or more programs, such as an enrollment program. For example, in some embodiments, engagement features can include, but are not limited to, a number of interface interactions (such as impressions, add-to-cart interactions, click interactions, etc.), number of explicit searches through an interface, interactions across specific sub-sections of a network interface (such as a home page, product page, search page, checkout page, cart page, browse page, etc.), interactions across certain platforms (such as webpage or application interactions), interactions across product segments or merchandise segments (such as grocery or general merchandise, etc.), and/or any other suitable engagement or interaction features.

In some embodiments, a set of model specific features include RFM model features such as recency values, frequency values, monitored values (e.g., tracked monetary values), customer segment classifications, and/or any other suitable model specific features. A user identifier can be segmented into multiple customer segment classifications based on historical interaction data and/or user preference selections.

At step 212, a user embedding 274 is generated. In some embodiments, the user embedding 274 is generated by a user encoding model 272. The user encoding model 272 can include a trained machine learning model configured to receive the set of user features 270 (or a subset thereof) and generate a vector embedding representation of the user. The user encoding model 272 can include any suitable encoding model. Although embodiments are illustrated with a separate user encoding model 272, it will be appreciated that the user encoding model 272 can be integrated into a trained model configured to perform additional operations, such as, for example, generate a user embedding and/or determine a user-task affinity, as discussed in greater detail below.

The user encoding model 272 can include any suitable encoding model, such as, for example, an autoencoder, a predictor, and/or any other suitable encoding model. The user encoding model 272 is configured to receive the set of user features 270 (or a subset thereof) and generate the user embedding 274 through one or more hidden layers configured to generate a vector representation of the received set of user features 270 (or a subset thereof). Any suitable autoencoder can be used, such as, for example, a denoising autoencoder, a sparse autoencoder, a deep autoencoder, a contractive autoencoder, an undercomplete autoencoder, a convolutional autoencoder, a variational autoencoder, and/or any other suitable autoencoder.

At step 214, a user-task affinity 278 is determined for each task in the set of potential tasks 260 with respect to the user identifier 254 by comparing a task embedding 266 for each task in the set of potential tasks 260 with a user embedding 274. The task embedding 266 can be compared to the user embedding 274 using any suitable comparison mechanism. For example, in some embodiments, a trained affinity model 276 is configured to compare the task embedding 266 and the user embedding 274 to determine a similarity for the given user (as represented by the user embedding 274) and a selected task (as represented by the task embedding 266). In some embodiments, the trained affinity model 276 is configured to cross-correlate the task embedding 266 and the user embedding 274 to generate a user-task affinity 278.

In some embodiments, the trained affinity model 276 is configured to generate a user-task affinity 278 (e.g., similarity) that is representative of a likelihood of a given user, as represented by the user embedding 274, engaging with or completing a given task, as represented by the task embedding 266. In some embodiments, the higher the user-task affinity 278 (e.g., the more similar) between the user embedding 274 and the task embedding 266, the higher the likelihood of the user engaging with an interface to select, execute, and/or complete the given task.

At step 216, the user-task affinity 278 for each task in the set of potential tasks 260 is ranked to generate a ranked set of tasks 280 for the user identifier 254. The ranked set of tasks 280 includes the same set of tasks as in the set of potential tasks 260, but ranked in order of affinity with respect to the user (e.g., ranked by probability of the user interacting with or completing the task).

At optional step 218, the ranked set of tasks 280 can be filtered to remove or combine similar tasks based on a given context. For example, in some embodiments, a ranked set of tasks 280 can be filtered by a task filter 282 to remove similar, context-appropriate tasks, such as removing a task related to free shipping on purchased goods when a second task related to free shipping on recurring purchases is also included in the ranked set of tasks 280. In some embodiments, a higher ranked task can be maintained and lower-ranked, similar tasks can be filtered. As another example, in some embodiments, a highly ranked task that is similar to a task included in a prior set of tasks (as discussed in greater detail below) can be removed due to the similarity to a recently completed task. It will be appreciated that filtering or combining of similar tasks introduces diversity into the ranked set of tasks 280 such that the method 200 avoids having only one type of task, tasks related to a single activity, and/or repetitive tasks ranked highest within the ranked set of tasks 280. Instead, the disclosed method 200 provides for diverse tasks to be ranked highly within the ranked set of tasks 280 and subsequently selected for presentation, for example, as discussed below with respect to steps 222-224.

At optional step 220, the ranked set of tasks 280 can be augmented by a set of basic, or default, tasks 284. For example, in some embodiments, a set of default tasks common to all users when initially engaging with an enrollment program can include, but are not limited to, signing up for participation in the program, downloading a mobile application related to the program and/or the provider of an interface, providing general information to the program, and/or other basic tasks. If a user has not yet completed a basic task, for example, as determined by a task tracking engine 262, the basic task can be inserted before (e.g., ranked higher) than any of the context-aware tasks in the ranked set of tasks 280. Alternatively, in some embodiments, basic tasks can be included in the ranked set of tasks 280 and have a weighting factor applied configured to position such tasks at the top of the ranked set of tasks 280.

At step 222, a set of top N ranked tasks 286 is selected for inclusion in a user interface. For example, in some embodiments, a set of the top 3 ranked tasks is selected from the ranked set of tasks 280. The selected set of top N ranked tasks 286 can include customized, user-context appropriate tasks selected by, for example, an affinity model 276 and/or basic tasks inserted into the ranked set of tasks 280 during optional step 220.

At step 224, a customized network interface 290 including customized interface elements 292a-292c related to and/or representative of the set of top N ranked tasks 286 is generated. The customized interface elements 292a-292c can include, for example, buttons, links, and/or other interactive elements to enable a user to engage with and/or complete a task without the user having to sort through unfamiliar interface pages to find those tasks. In some embodiments, the customized interface elements 292a-292c are inserted at predetermined positions and/or within predetermined containers within the interface.

Identification of relevant task-related interface elements associated with a current context of a user can be burdensome and time consuming for users, especially if users are unaware of the existence of the enrollment program, unaware of the tasks enabled by and/or required by enrollment in the program, and/or unaware of the location within an interface suitable for engaging with tasks provided by the enrollment program. Typically, a user can locate information regarding an enrollment program and/or individual tasks by navigating a browse structure, sometimes referred to as a “browse tree,” in which interface pages or elements are arranged in a predetermined hierarchy. Such browse trees typically include multiple hierarchical levels, requiring users to navigate through several levels of browse nodes or pages to arrive at an interface page of interest. Thus, the user frequently has to perform numerous navigational steps to arrive at a page containing information regarding enrollment programs and/or communication elements.

Systems including trained embedding models, trained affinity models, and trained ranking models, as disclosed herein, significantly reduce this problem, allowing users to locate context-relevant and appropriate tasks with fewer, or in some case no, active steps. For example, in some embodiments described herein, when a user is presented with one or more top ranked tasks, each task element includes, or is in the form of, a link to an interface page for engaging with the task and completing the task associated with the task element. Each recommendation thus serves as a programmatically selected navigational shortcut to an interface page, allowing a user to bypass the navigational structure of the browse tree. Beneficially, programmatically identifying context-appropriate tasks and presenting a user with navigations shortcuts to these tasks can improve the speed of the user's navigation through an electronic interface, rather than requiring the user to page through multiple other pages in order to locate the enrollment program and/or task element via the browse tree or via a search function. This can be particularly beneficial for computing devices with small screens, where fewer interface elements can be displayed to a user at a time and thus navigation of larger volumes of data is more difficult.

In some embodiments, the disclosed systems and methods for generating an interface including a set of context-aware customized interface elements is configured to optimize a large, diverse feature set to provide both context-appropriate and user-relevant tasks within a user interface. For example, in some embodiments, a set of user features 270 includes features selected from a diverse feature set that can include interactions between a user and one or more network interfaces, interactions between a user and locally distributed locations (e.g., stores, warehouses, etc.), historical data regarding prior interactions over each of the potential interaction channels, etc. The disclosed systems and methods provide personalized task identification for the user.

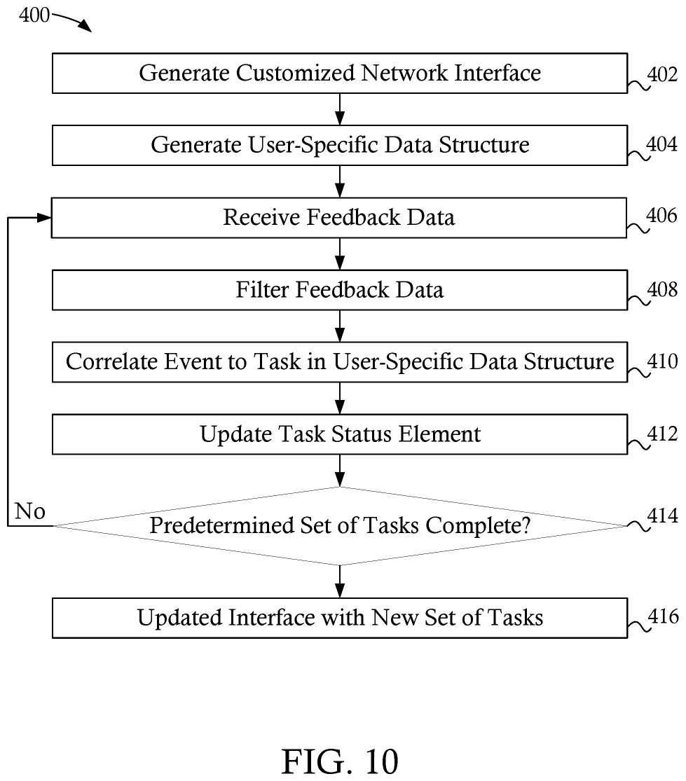

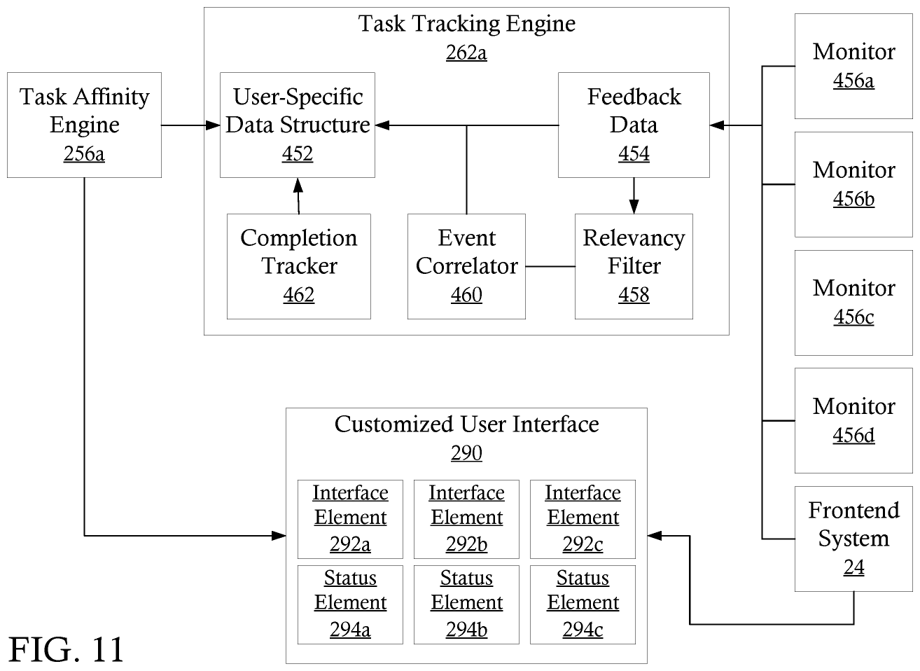

FIG. 10 is a flowchart illustrating a method 400 of monitoring and updating an interface including customized interface elements, in accordance with some embodiments. FIG. 11 is a process flow 450 illustrating various steps of the method of monitoring an updating an interface including customized interface elements, in accordance with some embodiments. At step 402, a customized network interface 290 including one or more context-aware, customized task interface elements is generated and provided to a user system, for example, via frontend system 24 and/or an operations layer of a network environment. For example, in some embodiments, a network interface 290 including a plurality of customized user interface elements 292a-292c is generated according to the method 200 discussed above. As discussed above, in some embodiments, a task affinity engine 256a is configured to generate real-time context aware task sets, e.g., curated task sets, that include context-appropriate tasks for a user.

At step 404, a user-specific data structure 452, e.g., a database document, is generated. The user-specific data structure 452 includes data elements representative of the selected tasks presented in the context-ware, customized task interface elements. For example, in some embodiments, the user-specific data structure 452 includes a document and each selected task is represented as an element within the document. In some embodiments, the selected tasks are received from the task affinity engine 256a and added to a persistent document associated with a user identifier of the user. Although embodiments are discussed herein including persistent database documents, it will be appreciated that any suitable data structure can be used to represent user interactions with selected tasks. As another example, in some embodiments, the user-specific data structure 452 includes a state machine, graph, and/or other structure configured to store persistent data elements related to tasks and/or other user data. The user-specific data structure 452 can be generated by any suitable system or engine, such as, for example, a task tracking engine 262a.

At step 406, feedback data 454 indicative of user interactions with the customized network interface 290 and/or indicative of interaction with one or more tasks available through the customized network interface 290. The feedback data 454 can be received from a device, such as a frontend system 24 in data communication with a user device displaying the customized network interface 290, and/or can be obtained by one or more activity observation monitors 456a-456d. In some embodiments, the feedback data 454 indicates that a user has completed an action presented in a customized interface element, such as a customized interface element 292a-292c of the customized network interface 290.

In some embodiments, the feedback data 454 is generated to one or more activity observation modules 456a-456d. The activity observation modules 456a-456d are configured to observe a predetermined data stream and/or a portion of a predetermined data stream and extract data indicative of actions, activities, or other interactions with a networked environment. When an activity observation module 456a-456d identifies data indicative of a predetermined action, the activity observation module 456a-456d generates feedback data 454 including, for example, an event indicator. The event indicator can be provided to one or more modules for processing, such as a relevancy filter, as discussed in greater detail below. The activity observation modules 456a-456d can include any suitable observation modules, such as, for example, an order fulfillment system observation module, a benefit usage observation module, an activity or clickstream observation module, a customer account observation module, and/or any other suitable observation module.

At step 408, the feedback data 454, e.g., one or more event indicators, is filtered to determine whether the feedback data 454 relates to completion of a potential task associated with a predetermined set of tasks, such as tasks associated with an enrollment program. In some embodiments, a relevancy filter 458 is configured to receive an event indicator or other feedback data 454 from an activity observation module 456a-456d and determine if the event is relevant to a user for a predetermined context, for example, is relevant to a user enrolled in an enrollment program (e.g., certain events may be relevant only if a user is enrolled in a benefits or enrollment program). If the event is potentially relevant to the user, e.g., if the event is appropriate for the user's context, the event indicator is provided to an event correlator for further processing. However, if the event is not relevant to a user, e.g., if the user is not enrolled in the necessary program and/or does not have the appropriate context, the event is ignored.

At step 410, when an event indicator is relevant to a user, for example as determined by the relevancy filter 458, the event indicator is correlated to a task identified in the persistent, user-specific data structure 452. In some embodiments, an event correlator 460 is configured to associate an event indicator with a data element indicative of a task associated with a user (e.g., appropriate for the user context) and stored within a user-specific data structure 452. The event correlator 460 can be configured to identify a specific task associated with the event indicator and/or a general class of tasks associated with the event indicator. For example, if an event indicator is related to utilizing a particular benefit provided by an enrollment program, the event correlator 460 can update both a first data element of the user-specific data structure 452 related to utilization of any benefit provided by the enrollment program and/or a second data element related to utilization of the particular benefit associated with the event indicator.

At step 412, a task status element 294a-294c included in the customized network interface 290 can be updated and/or set to a predetermined value based on the update to the user-specific data structure. For example, when an event indicator is correlated to completion of a first task, a first task status element 294a can be updated and/or set to indicate completion of the first task. Similarly, when an event indicator is correlated to a second task or a third task, the corresponding task status elements 294b, 294c can be updated and/or set to indicate completion of the corresponding task. Although embodiments are illustrated including three customized interface elements 292a-292c and three task status elements 294a-294c, it will be appreciated that any suitable number of customized interface elements 292a-292c and corresponding task status elements 294a-294c can be included in a customized network interface 290.

At step 414, a determination is made whether a predetermined set of tasks has been completed. For example, in some embodiments, the set of customized interface elements 292a-292c presented on a customized network interface 290 represent a predetermined set of tasks selected, for example, by a task affinity engine 260a for a user. In some embodiments, a completion tracker 462 determines when each task in a predetermined set of tasks is completed. When all of the tasks in a predetermined set of tasks is completed, the completion tracker 462 can initiate a reward mechanism to provide a reward to the user, e.g., to an account associated with a user identifier, based on the completion of the predetermined set of tasks.

For example, in some embodiments, a set of three tasks is selected by a task affinity engine 260a, as discussed above with respect to FIGS. 6-7. The selected tasks are embodied in customized interface elements 292a-292c included within a customized network interface 290. As a user completes each of the tasks, for example, by interacting with a customized interface element 292a-292c to navigate to an interface page associated with the selected task, the user-specific data structure 452 maintained for the user is updated to indicate completion of each task. When each of the three tasks are completed, a completion tracker 462 identifies completion of the predetermined set of tasks and initiates a reward module configured to generate a reward for a user, e.g., to associate a reward with the user identifier. In some embodiments, the reward is indicated by updating the user-specific data structure 452, although it will be appreciated that any suitable reward can be presented in any suitable form.

At step 416, the customized network interface 290 is updated to include a new set of customized interface elements 292a-292c corresponding to a new set of highest-ranked tasks selected for a user. For example, in some embodiments, the customized network interface 290 is updated to include the next N tasks identified by a task affinity engine 256a during a prior affinity determination. As another example, in some embodiments, a new customized interface is generated, for example as discussed above with respect to FIGS. 6-7, and particularly with steps 204-220, with each of the completed tasks and similar tasks being removed from the ranking process.

In some embodiments, the presentation of customized interface elements 292a-292c in sequential sets is configured to provide a user with tasks of increasing complexity or difficulty. For example, in some embodiments, when a user initially signs up for or interacts with an enrollment program, a task affinity engine 256a can generate an initial set of customized interface elements 292a-292c associated with a set of basic tasks common to all new users. For example, as discussed above with respect to FIGS. 6-7, basic tasks can be inserted into a ranked set of tasks 280 with rankings placing the basic tasks at the top of the ranking. When a user completes the initial set of tasks associated with the initial set of customized interface elements 292a-292c, the initial set is replaced with a subsequent set that can include basic and/or personalized tasks selected, for example, by a task affinity engine 256a as discussed above. As a user completes each subsequent set of tasks, e.g., completing all basic tasks and initial personalized tasks, the task affinity engine 256a can identify tasks of increasing complexity, e.g., the user embedding 274 generated for a user identifier 254 can change over time as the features used to generate the user embedding 274 change through interactions with the network interface. Changes to the user embedding 274 cause task embeddings 266 for different tasks, such as more involved or complex tasks, to have a higher affinity and be higher ranked for a user, resulting in customized interface elements 292a-292c for higher complexity tasks being presented within a network interface 290.

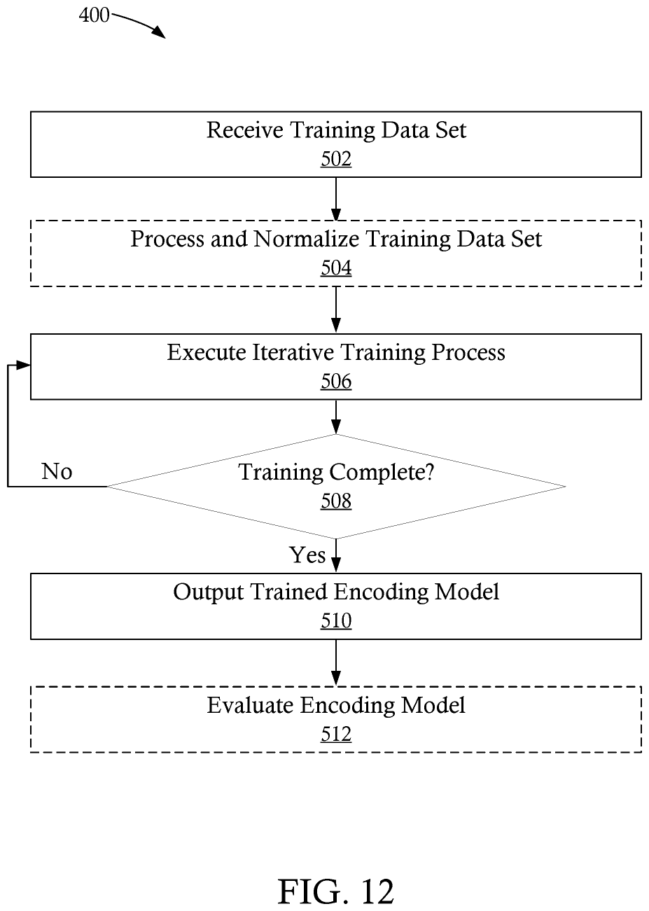

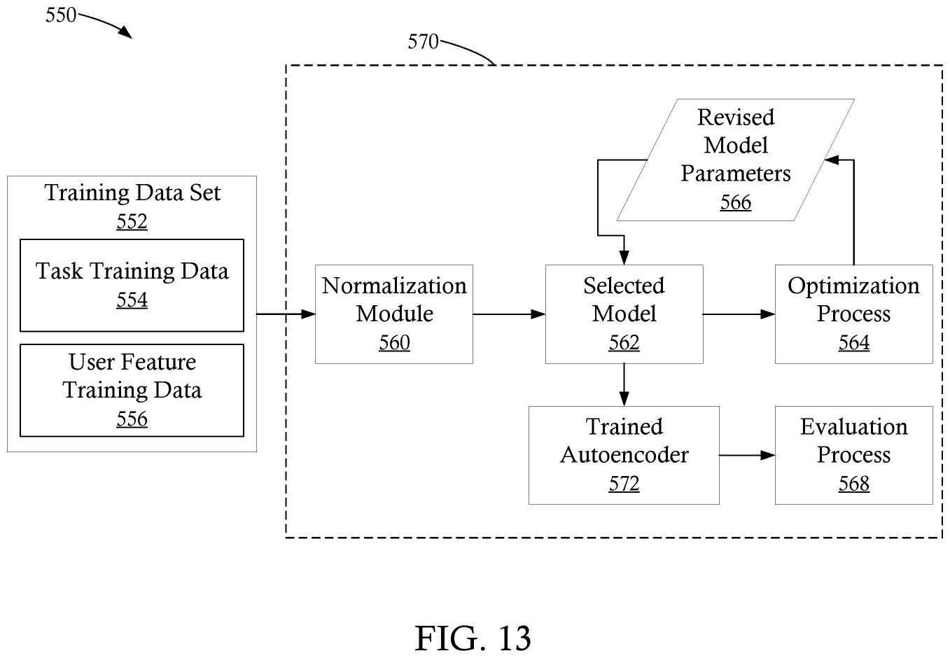

FIG. 12 is a flowchart illustrating a method 500 of training an autoencoder, in accordance with some embodiments. FIG. 13 is a process flow 550 illustrating various steps of the method 500 of training an autoencoder network, in accordance with some embodiments. At step 502, a training dataset 552 is received. The training dataset 552 can include unlabeled data or datasets from a domain relevant to the training of the autoencoder. For example, in embodiments including training of a word2vec model for generating task embeddings, the training dataset 552 includes task training data 554 including individual task descriptions, e.g., single words or phrases. As another example, in embodiments including training of an autoencoder for generating user embeddings, the training dataset 552 includes user feature training data 556.

At optional step 504, the received training dataset 552 is processed and/or normalized by a normalization module 560. For example, in some embodiments, the training dataset 552 can be augmented by imputing or estimating missing values of one or more features associated with certain elements. In some embodiments, processing of the received training dataset 552 includes outlier detection configured to remove data likely to skew training of an autoencoder. In some embodiments, processing of the received training dataset 552 includes removing features that have limited value with respect to training of an autoencoder.

At step 506, an iterative training process is executed to train a selected model framework 562. For example, a model training engine 570 can be configured to obtain a model framework 562 including an untrained (e.g., base) machine learning framework, such as an encoding-decoding framework, and/or a partially or previously trained model (e.g., a prior version of a trained autoencoder or word2vec model, a partially trained model from a prior iteration of a training process, etc.), from a model store, such as a model store database 34. The model training engine 570 is configured to iteratively adjust parameters (e.g., hyperparameters) of the intermediate layers of the untrained model 558 to generate a trained autoencoder.

For example, in some embodiments, an encoding portion, or embedding matrix, of an autoencoder includes a set of hidden layers, each having one or more weights, configured to convert an input to an N-dimensional vector, as illustrated in FIG. 5. Similarly, a decoding portion, or context matrix, includes a set of hidden layers, each having one or more weights, configured to convert the N-dimensional vector to an output. The iterative training process adjusts the weights of a selected model 562 until the input and the output are identical (or within a predetermined margin of error).

In some embodiments, the model training engine 570 implements an iterative training process that generates a set of revised model parameters 566 during each iteration. The set of revised model parameters 566 can be generated by applying an optimization process 564 to the cost function of the selected model 562 and/or a cost function of an underlying hidden layer of the model. The optimization process 564 can be configured to reduce the cost value (e.g., reduce the output of the cost function) at each step by adjusting one or more parameters during each iteration of the training process.

After each iteration of the training process, at step 508, the model training engine 570 determines whether the training process is complete. The determination at step 508 can be based on any suitable parameters. For example, in some embodiments, a training process can complete after a predetermined number of iterations. As another example, in some embodiments, a training process can complete when it is determined that the cost function of the selected model 562 has reached a minimum, such as a local minimum and/or a global minimum.

At step 510, a trained autoencoder 572 is output and provided for use in a interface generation method, such as the method 200 discussed above with respect to FIGS. 6-7. The trained autoencoder 572 can be generated by truncating a trained encoding-decoding model to keep only the input, embedding matrix, and hidden layer (e.g., the N-dimensional vector output of the embedding matrix). The truncated network is a trained autoencoder 572 configured to output a vector representation (e.g., embedding) of an input.

At optional step 512, a trained autoencoder 572 can be evaluated by an evaluation process 568 to determine the efficacy of the model. The trained autoencoder 572 can be evaluated based on any suitable metrics, such as, for example, an F or F1 score, normalized discounted cumulative gain (NDCG) of the model, mean reciprocal rank (MRR), mean average precision (MAP) score of the model, and/or any other suitable evaluation metrics. Although specific embodiments are discussed herein, it will be appreciated that any suitable set of evaluation metrics can be used to evaluate a trained autoencoder 572. In some embodiments, the disclosed autoencoder, and methods of generating a trained autoencoder, can be adapted for encoding of any suitable input, such as any suitable set of user features.

Although the subject matter has been described in terms of exemplary embodiments, it is not limited thereto. Rather, the appended claims should be construed broadly, to include other variants and embodiments, which can be made by those skilled in the art.

What is claimed is:

1. A system, comprising:
a non-transitory memory;
a processor communicatively coupled to the non-transitory memory, wherein the processor is configured to read a set of instructions to:
receive a request for a user interface, wherein the request includes a user identifier;
obtain a set of features from a database, wherein the set of features are associated with the user identifier in the database;
generate a user embedding by applying an autoencoder to the set of features;
obtain a set of potential tasks, wherein the set of potential tasks are associated with an enrollment portion of the user interface;
generate a task embedding for each potential task in the set of potential tasks;
generate a user-task affinity for each potential task by comparing the user embedding to each task embedding;
generate a ranked set of tasks by ranking each potential task based on the user-task affinity;
generate a set of interface elements related to a predetermined number of highest ranked tasks in the ranked set of tasks;
generate the user interface including the set of interface elements; and
transmit the user interface to a device that generated the request for the user interface.

2. The system of claim 1, wherein the set of features comprises transactional features, demographic features, enrollment program features, intent features, engagement features, recency, frequency, monetary value (RFM) features, or any combination thereof.

3. The system of claim 1, wherein each task embedding is generated by a word2vec model.

4. The system of claim 1, wherein the ranked set of tasks is filtered by a task filter to remove similar, context-appropriate tasks.

5. The system of claim 1, wherein the ranked set of tasks is augmented by a set of basic tasks.

6. The system of claim 1, wherein the processor is configured to read the set of instructions to:
receive feedback data including at least one event indicator;
correlate the at least one event indicator to one of the predetermined number of highest ranked tasks in the ranked set of tasks; and
update a task status element associated with the user identifier based on the correlation between the event indicator and the one of the predetermined number of highest ranked tasks in the ranked set of tasks.

7. The system of claim 1, wherein the user interface is updated to include a subsequent predetermined number of highest ranked tasks when the predetermined number of highest ranked tasks in the ranked set of tasks is completed.

8. A computer-implemented method, comprising:
receiving, by a processor, a request for a user interface, wherein the request includes a user identifier;
obtaining a set of features from a database, wherein the set of features are associated with the user identifier in the database;
generating a user embedding by applying an autoencoder to the set of features;
obtaining a set of potential tasks, wherein the set of potential tasks are associated with an enrollment portion of the user interface;
generating a task embedding for each potential task in the set of potential tasks;
generating a user-task affinity for each potential task by comparing the user embedding to each task embedding;
generating a ranked set of tasks by ranking each potential task based on the user-task affinity;
generating a set of interface elements related to a predetermined number of highest ranked tasks in the ranked set of tasks;
generating the user interface including the set of interface elements; and
transmitting the user interface to a device that generated the request for the user interface.

9. The computer-implemented method of claim 8, wherein the set of features comprises transactional features, demographic features, enrollment program features, intent features, engagement features, recency, frequency, monetary value (RFM) features, or any combination thereof.

10. The computer-implemented method of claim 8, wherein each task embedding is generated by a word2vec model.

11. The computer-implemented method of claim 8, wherein the ranked set of tasks is filtered by a task filter to remove similar, context-appropriate tasks.

12. The computer-implemented method of claim 8, wherein the ranked set of tasks is augmented by a set of basic tasks.

13. The computer-implemented method of claim 8, comprising:
receiving feedback data including at least one event indicator;
correlating the at least one event indicator to one of the predetermined number of highest ranked tasks in the ranked set of tasks; and
updating a task status element associated with the user identifier based on the correlation between the event indicator and the one of the predetermined number of highest ranked tasks in the ranked set of tasks.

14. The computer-implemented method of claim 8, wherein the user interface is updated to include a subsequent predetermined number of highest ranked tasks when the predetermined number of highest ranked tasks in the ranked set of tasks is completed.

15. A non-transitory computer-readable storage medium storing instructions which, when executed by one or more processors, cause one or more devices to perform operations comprising:
receiving, by a processor, a request for a user interface, wherein the request includes a user identifier;
obtaining a set of features from a database, wherein the set of features are associated with the user identifier in the database;
generating a user embedding by applying an autoencoder to the set of features;
obtaining a set of potential tasks, wherein the set of potential tasks are associated with an enrollment portion of the user interface;
generating a task embedding for each potential task in the set of potential tasks;
generating a user-task affinity for each potential task by comparing the user embedding to each task embedding;
generating a ranked set of tasks by ranking each potential task based on the user-task affinity;
generating a set of interface elements related to a predetermined number of highest ranked tasks in the ranked set of tasks;
generating the user interface including the set of interface elements; and
transmitting the user interface to a device that generated the request for the user interface.

16. The non-transitory computer-readable medium of claim 15, wherein the set of features comprises transactional features, demographic features, enrollment program features, intent features, engagement features, recency, frequency, monetary value (RFM) features, or any combination thereof.

17. The non-transitory computer-readable medium of claim 15, wherein each task embedding is generated by a word2vec model.

18. The non-transitory computer-readable medium of claim 15, wherein the ranked set of tasks is filtered by a task filter to remove similar, context-appropriate tasks.

19. The non-transitory computer-readable medium of claim 15, wherein the ranked set of tasks is augmented by a set of basic tasks.

20. The non-transitory computer-readable medium of claim 15, wherein the instructions cause the one or more devices to perform operations comprising:
receiving feedback data including at least one event indicator;
correlating the at least one event indicator to one of the predetermined number of highest ranked tasks in the ranked set of tasks; and
updating a task status element associated with the user identifier based on the correlation between the event indicator and the one of the predetermined number of highest ranked tasks in the ranked set of tasks.
